(19) United States
(12) Patent Application Publication
(10) Pub. No.: US 2007/0279204 A1
(43) Pub. Date: Dec. 6, 2007

(54) Method and system for tire inflation monitoring

(75) Inventors: Eliezer Adar, Sde Varburg (IL); Alexander Antonenko, Calgary (CA)

Correspondence Address: OBLON, SPIVAK, MCCLELLAND MAIER & NEUSTADT, P.C., 1940 DUKE STREET, ALEXANDRIA, VA, 22314, US

(73) Assignee: ADVANCED CODING SYSTEMS LTD, Even Yehuda (IL)

(21) Appl. No.: 11/444,378

(22) Filed: Jun. 1, 2006

(51) Int. Cl. B60C 23/00

(52) U.S. Cl. 340/447

(57) ABSTRACT

A system for sensing an inflation condition of a tire includes an interrogating device configured to transmit an interrogating signal, a radiating device configured to radiate a response signal in response to the interrogating signal, and a sensing device. The radiating device is attached to the tire, and the sensing device is configured to receive the response signal from the radiating device and determine an inflation condition of the tire based on a frequency content of the received response signal. A method and computer program product having instructions for monitoring tire inflation are also described.

### BACKGROUND OF THE INVENTION

1. Field of the Invention

The present invention relates to a tire pressure monitoring system to be mounted, for example, on a vehicle, and particularly to a technique for accurately monitoring tire pressure with a relatively simple structure.

2. Discussion of the Background

Correct tire pressure is a critical factor in the safe operation and performance of a motor vehicle. Over-inflated tires often result in decreased tire life and vehicle performance. Under-inflated tires typically reduce safety since they do not provide a reliable interface with the road.

There are known systems for tire pressure monitoring based on transmitting RF signals from a pressure transducer installed inside a tire, to a receiver. For example, U.S. Pat. No. 6,011,463 to Cormier, describes systems consisting of air hoses, pressure sensors, radio transmitters with antennas, a radio receiver, a display unit with lights, batteries, and associated electrical components. An assembly mounted on the front of each wheel, over or in place of the hubcap, includes an air pressure monitor utilizing air pressure inflation valves, a radio transmitter with a battery cell, a radio transmitter antenna, and high/low indicator lights.

Such wireless (e.g., RF) systems provide rather accurate pressure monitoring, but they are complex and very expensive. In addition, these systems are difficult in exploitation.

There are known less expensive systems based on indirect inflation measurement. For example Japanese Patent Publication No. 5-55322 describes a method for determining lowering of air pressure based on a ratio between the total angular velocities of a pair of tires positioned in one diagonal line and total angular velocities of the other pair of tires positioned in the other diagonal line. Japanese Patent No.2836652 to Taguchi et al. describes discloses a tire pressure detecting system for determining lowering of air pressure (under-inflation of the tire) based on the idea that the peak value of the tire vibration frequency spectrum lowers or shifts (i.e., along the frequency axis) in accordance with velocity of the vehicle and with respect to the normal air pressure values stored in a ROM or the like.

A disadvantage of such conventional indirect systems is low accuracy that may be insufficient for modern requirements.

### SUMMARY OF THE INVENTION

Accordingly, one object of this invention is to provide a novel system for sensing an inflation condition of a tire. The system includes an interrogating device configured to transmit an interrogating signal, a radiating device configured to radiate a response signal in response to the interrogating signal, and a sensing device. The radiating device is attached to the tire, and the sensing device is configured to receive the response signal from the radiating device and determine an inflation condition of the tire based on a frequency content of the received response signal.

Another object of this invention is to provide a novel tire configured to be monitored by a monitoring device configured to determine a tire inflation condition based on a frequency content of a signal received from the tire. The tire includes an attached radiating device configured to radiate a response signal in response to an interrogating signal received from the monitoring device.

Another object of this invention is to provide a novel sensor configured to sense an inflation condition of a tire that radiates a response signal in response to an interrogating signal. The sensor includes an interrogating device configured to transmit an interrogating signal, and a sensing device configured to receive the response signal from the tire and determine an inflation condition of the tire based on a frequency content of the received response signal.

Another object of this invention is to provide a novel method for monitoring an inflation condition of a tire. The method includes steps of transmitting an interrogating signal from an interrogating device, radiating a response signal, from a radiating device attached to the tire, in response to the interrogating signal, receiving the response signal at a sensing device, and determining an inflation condition of the tire based on a frequency content of the received response signal.

Another object of this invention is to provide a novel computer program product storing program instructions which, when executed by a processor for monitoring a tire, result in execution of steps comprising: transmitting an interrogating signal from an interrogating device; radiating a response signal, from a radiating device attached to the tire, in response to the interrogating signal; receiving the response signal at a sensing device; and determining an inflation condition of the tire based on a frequency content of the received response signal.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a signal diagram of an electromagnetic response of an embodiment of the present invention with a relatively low level of applied stress;

FIG. 1B is a signal diagram of an electromagnetic response of an embodiment of the present invention with a relatively high level of applied stress;.

FIG. 2 is a schematic diagram of a system for tire inflation monitoring according to an embodiment of the present invention;.

FIG. 3 is an isometric view of a vehicle wheel according to an embodiment of the present invention with embedded amorphous metal ribbon;

FIG. 4A is a side view of magnetic elements of a reader according to an embodiment of the present invention;

FIG. 4B is a top view of magnetic elements of a reader according to an embodiment of the present invention; and

FIG. 5 is a block diagram of a reader according to an embodiment of the present invention.

### DETAILED DESCRIPTION OF THE PREFERRED EMBODIMENTS

One aspect of the present invention is a method of tire condition monitoring, including monitoring of tire inflation, which is accurate, inexpensive and simple to implement. This method includes electromagnetic response detection of amorphous metal ribbon or wire embedded inside a tire protector. Amorphous ferromagnetic materials may be very sensitive to mechanical stresses. For example, it is known that merit factor for “METGLASS” amorphous metal ribbon may reach a value of 1500, which is substantially higher than that for other known materials. Merit factor is defined as a ratio: F=(δZ/Z₀)/δ_{ε} Where Z₀ is an impedance of a magnetic material, δZ is a change of the impedance under an applied stress, and δ_{ε} is a deformation of the magnetic material under applied stress (i.e., δ_{ε}=Δl/l, l is a length of magnetic material). By way of comparison, the merit factor for a semiconductor material may reach a value of only 100, and the merit factor for a metal foil and wire may reach only a value of 2.

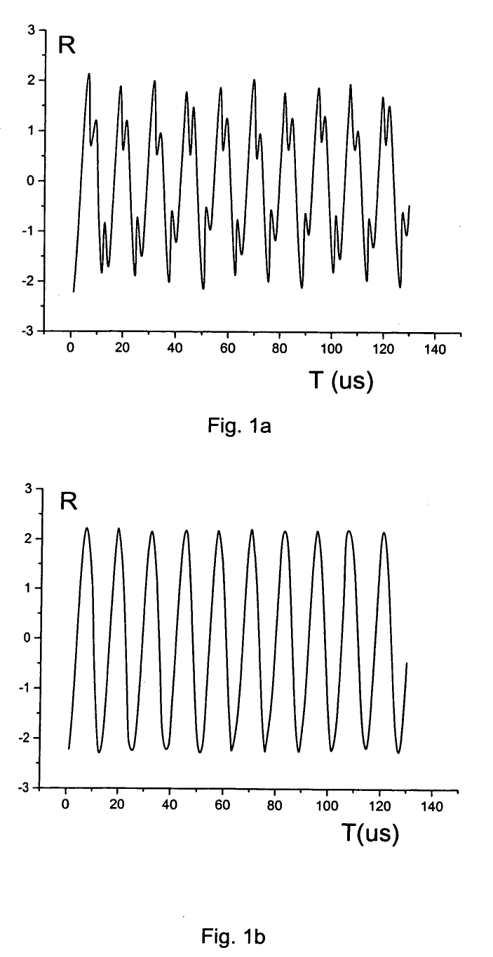

An amorphous metal ribbon or wire interrogated by an alternating magnetic field will produce an electromagnetic response, and parameters such as amplitude and spectrum of harmonics of the electromagnetic response will depend on a mechanical stress applied to the amorphous metal ribbon or wire. An example of the effect of mechanical stress on electromagnetic response R is shown over time T in FIGS. 1A and 1B.

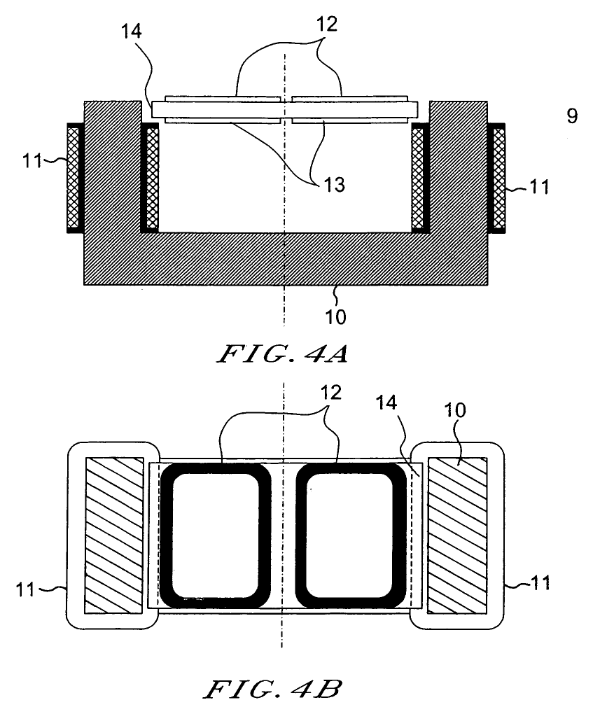

FIGS. 1A and 1B show intermodulation signals detected in an embodiment of the present invention, such as shown in FIG. 4. The signals represent an electromagnetic response of the amorphous metal ribbon in an initial state (FIG. 1A) and after stress application (FIG. 1B). Even without Fourier analysis, it is clearly seen that the signal at FIG. 1A contains substantially higher second harmonic components than the signal at FIG. 1B due to the drop of magnetic permeability. Significance of magnetic permeability is explained below.

Amorphous metal ribbon or wire may be embedded in a tire during tire fabrication. Automobile users will not feel any difference in using tires with embedded amorphous metal ribbons or wires in comparison with conventional tires.

In one embodiment of the present invention, a radiating device made of amorphous metal ribbon, such as a Co-based amorphous metal ribbon with negative magnetostriction, is embedded inside the tire protector for measurements of tire inflation. Amorphous metal ribbon with negative magnetostriction is characterized by high sensitivity to mechanical stress over a wide range of stress levels. This ribbon demonstrates high permeability under stress-free conditions. With the increase of applied stress, the permeability of the ribbon drops. Thus, by subjecting the ribbon to an alternating magnetic field interrogation by an interrogating device, the mechanical stress of the ribbon may be determined by sensing a resulting magnetic field at a sensing device. Further, the tire condition and in particular the tire inflation may be determined from the determined ribbon stress.

In this embodiment, an intermodulation response of an embedded amorphous metal ribbon is used for tire inflation measurement. The ribbon is interrogated by an alternating magnetic field produced by an interrogating device and having two substantially different frequency components. The first frequency is, for example, 8 kHz and the second frequency is, for example, 12 Hz. The ribbon undergoes magnetization at the first frequency of 8 kHz and generates an electromagnetic response at high harmonics of the interrogating frequency. Further, the radiating device ribbon generates the electromagnetic response by passive radiation (i.e., without the use of an external electrically connected power source or amplifier). In this embodiment, an electromagnetic response at the second harmonic of the first frequency (i.e., 16 kHz) is detected. The second low frequency magnetic field (i.e., the field produced in this example by the 12 Hz frequency component) is used for periodical sweeping amorphous metal ribbon between saturated states. While sweeping, the amorphous metal ribbon passes through a state at which its permeability reaches maximum. At the state close to maximum magnetic permeability, the amorphous metal ribbon exhibits the highest electromagnetic response. The higher electromagnetic response, the greater the detected signal. In addition, it is important to detect the electromagnetic response at the same state of amorphous metal ribbon (i.e., at state of maximum permeability) to eliminate the effect of an external DC magnetic field. The use of two magnetic fields allows high accuracy in measurement to be achieved, because using two frequencies may exclude the effect of external DC magnetic fields, such as the Earth magnetic field, on the measurement results.

For example, it is known that external magnetic field does not affect the maximum permeability of magnetic material. It may only shift magnetic material to the state where permeability is not maximum. Electromagnetic response in this shifted state will be lower than a response in the state close to maximum permeability. Excessive tension in the ribbon also decreases electromagnetic response, but it is due to decreasing of maximum permeability. The maximum permeability may serve as a parameter for tension measurement. For this reason, it is useful to detect signal response when magnetic material is close to the state of maximum permeability. The two-frequency technique described herein allows discrimination between the effects of tension and the effects of an external magnetic field. The receiving device may pick-up the maximum signal throughout the period of the lower interrogating frequency. This signal depends on tension only because it is detected when magnetic material is close to the state of maximum permeability.

FIG. 1A is a signal diagram of a detected intermodulation signal (i.e. the signal detected when magnetic material is close to the state of maximum permeability) in the response of a stress-free condition of a tire according to an embodiment of the present invention. In this example, the electromagnetic response is relatively high (i.e., compared to the response of amorphous ribbon with excessive tension) at the second harmonic of the high frequency, indicating that the amorphous metal ribbon is at a stress-free condition. With an increase of applied stress, the electromagnetic response drops in amplitude. In addition, the electromagnetic response contains mainly the first harmonics of interrogating frequency while the second harmonics decreases.

FIG. 1B is a signal diagram of a detected intermodulation signal in the response of a tire under increased stress. The amplitude of the intermodulation signal depends mostly on the applied stress and is relatively independent of external magnetic fields.

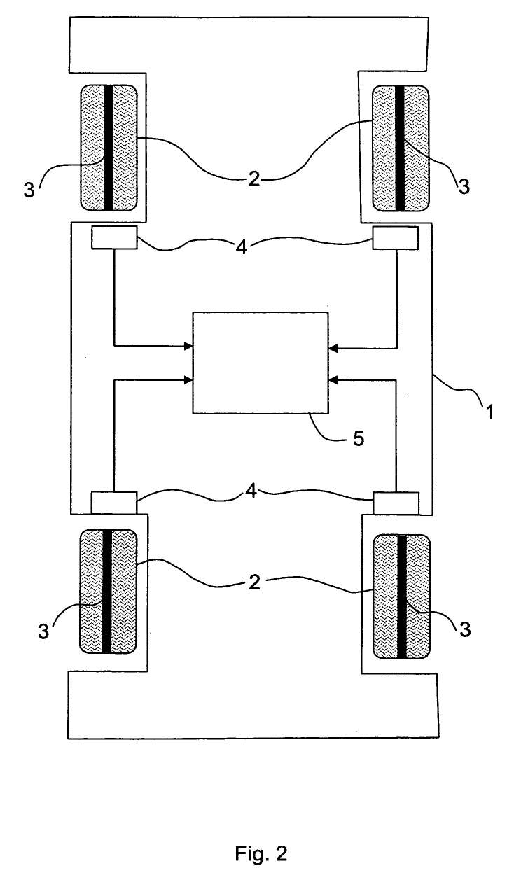

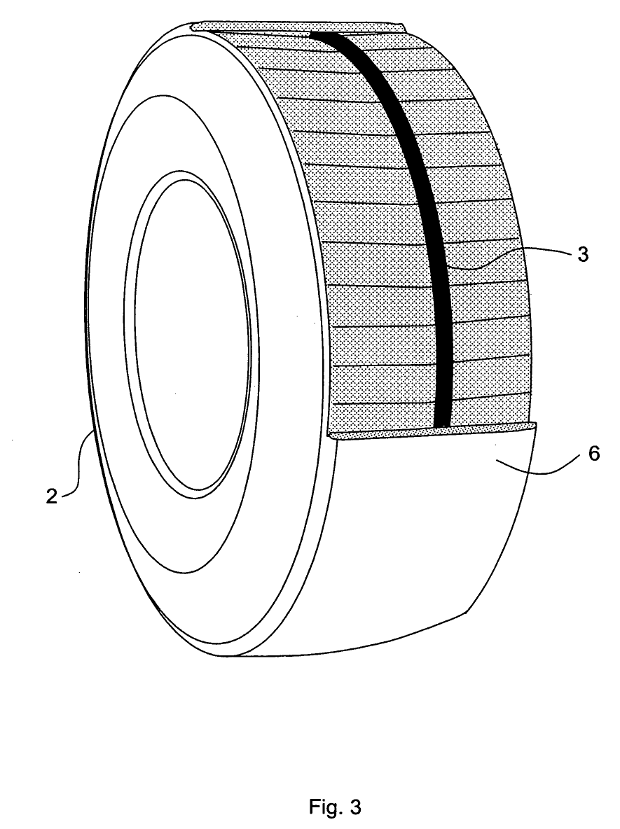

A schematic diagram of an embodiment of the present invention is shown in FIGS. 2 and 3. A central computer 5 may send signals periodically to readers 4 installed close to vehicle wheels 2. The signals may initiate or query the readers 4. In response to the signal from the central computer 5, the reader 4 may start interrogating amorphous metal ribbons 3 embedded inside the tire protector 6. In response to the interrogating magnetic field, amorphous metal ribbon 3 may generate an electromagnetic signal which is detected by the reader 4. The detected signal may be converted to a digital format and transmitted to the central computer 5.

FIG. 4A shows a side view and FIG. 4B show a top view of an example of a magnetic unit 9 of a reader 4 according to an embodiment of the present invention. Magnetic unit 9 of the reader 4 may include interrogating coils 11 wound on a ferrite core 10. Pick-up coils 12 may be fixed at a support plate 14. At another side of the plate 14, compensation coils 13 are arranged. These coils 12 may be connected to the pick-up coils 12 to minimize spurious signals induced in the coils 12 by the interrogating magnetic field. For this reason, the position of support plate 14 with the pick-up coils 12 and the compensation coils 13 may be adjusted relative to the ferrite core 10.

Another aspect of the present invention is a system for tire condition monitoring. The system includes of vehicle wheels with embedded amorphous metal ribbons or wires, at least one device for interrogation of embedded ribbons or wires and detection of their responses, and a central computer of the vehicle, which receives information from all detector units, analyses this information, and displays it in a form convenient for the vehicle driver. In case a substantial deviation of tire condition from normal state is registered, the computer provides a warning to the driver. The detector units are installed at the non-rotating base of the vehicle close to each wheel. There is no need for mechanical or electrical links between the vehicle's base and the rotating wheels since interrogation of amorphous metal ribbons or wires is produced exclusively through electromagnetic fields. In other words, the amorphous metal ribbon or wire is electrically isolated from the interrogating and sensing devices, and the amorphous metal ribbon or wire is a passive device that does not require an external electrically connected power source.

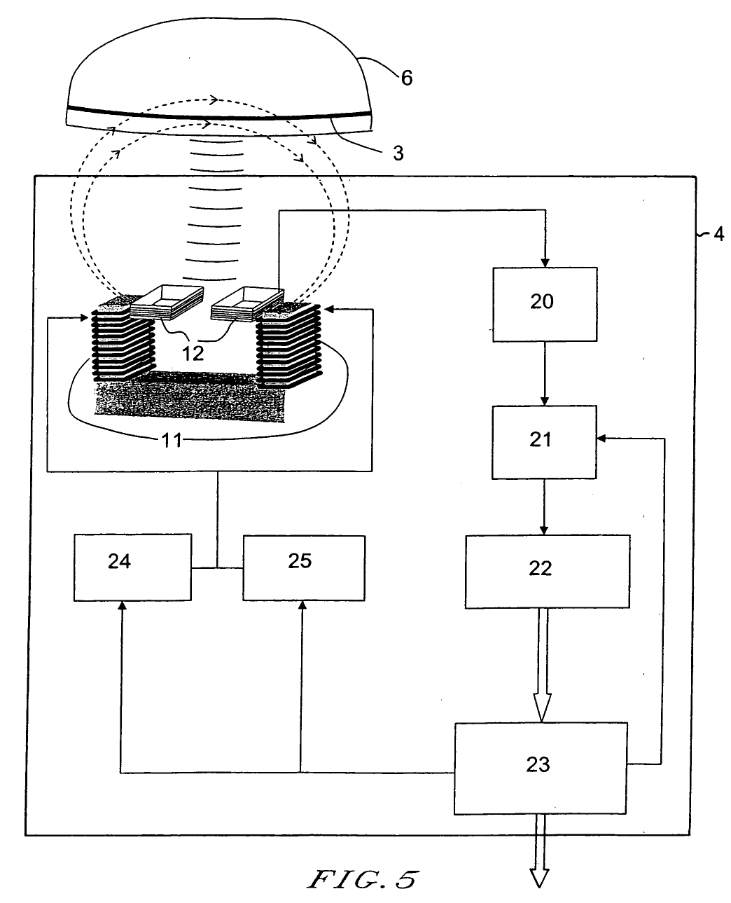

FIG. 5 is a block diagram showing additional features of a reader according to an embodiment of the present invention. The reader 4 comprises a first driver 24 and a second driver 25, which provide alternating current through interrogating coils 11. The first driver 24 may provide current of a relatively high frequency while the second driver 25 provides a relatively low frequency current. For example, the high frequency may be 8 kHz, and the low frequency may be 12 Hz. The response signal comes to a band-pass amplifier 20 which has a maximum gain at the second harmonic of the higher interrogating frequency (i.e., 16 kHz). After the band pass amplifier 20, the filtered signal comes to a phase detector 21 locked at the second harmonic of the high frequency signal. The signal at the output of the phase detector 21 represents the second harmonic amplitude of the higher interrogating frequency, modulated by the lower frequency. The peak-to-peak value of that signal correlates with an amount of tension applied to the amorphous metal ribbon 3. From the output of the phase detector 21, the phase detected signal comes to an analog-to-digital converter 22, and then to a microcontroller 23. The microcontroller 23 transmits data to the central computer 5. In addition, the microcontroller 23 may provide control signals for the drivers 24, 25, and the phase detector 21.

In another embodiment of the present invention, at least one amorphous wire with negative magnetostriction is embedded in the tire as one or more of the filaments in the tire cord thread (not shown in the drawings). This at least one amorphous wire can be for example, an in-water-cast wire or a glass-coated amorphous wire. Glass-coated amorphous wires are preferable since these can be manufactured in a non-expensive, one-stage process, with high mechanical strength and consistent dimensions. For example, wires of Cobalt-based alloy containing 10% boron and 15% silicon by atomic percentage can be used, with metal core diameters of 30 to 50 microns, and with glass coat thickness of 2 to 10 microns.

The process of the wire response detection and the determination of the tire inflation in the present embodiment can be performed similarly to the process described in the previous embodiment.

The present system for tire condition monitoring features substantial advantages in comparison with conventional systems.
The system may provide accurate inflation measurement for all wheels of the vehicle;
The system cost may be relatively low since it does not contain complicated electronics units installed on rotating wheels and operating at harsh environmental conditions;
The system may not require any expensive batteries;
System exploitation is not associated with additional expenses such as replacement of electronics units and batteries on rotating wheels, which might require specially equipped stations operated by specially trained personnel. The present system suggests a standard service typical for modern vehicles, which may be provided by any workshop or garage.

It should be understood that the invention is disclosed by the way of non-limiting examples only. Those skilled in the art will readily appreciate that various modifications and changes can be applied to the invention as hereinbefore exemplified without departing from its scope defined in and by the appended claims.

Numerous modifications and variations of the present invention are possible in light of the above teachings. It is therefore to be understood that within the scope of the appended claims, the invention may be practiced otherwise than as specifically described herein.

1. A system for sensing an inflation condition of a tire, said system comprising:
an interrogating device configured to transmit an interrogating signal;
a radiating device configured to radiate a response signal in response to the interrogating signal, said radiating device attached to the tire; and
a sensing device configured to receive the response signal from the radiating device and determine an inflation condition of the tire based on a frequency content of the received response signal.

2. The system of claim 1, wherein the radiating device is configured to vary a frequency content of the response signal based on an amount of deformation of the tire.

3. The system of claim 1, wherein the radiating device is configured to passively radiate the response signal in response to the interrogation signal.

4. The system of claim 1, wherein the radiating device is configured to decrease a higher harmonic component of the response signal when an amount of deformation of the tire increases.

5. The system of claim 1, wherein
the interrogating device is configured to transmit the interrogating signal including a high frequency interrogating component at a high frequency and a low frequency interrogating component at a low frequency, and
the radiating device is configured to radiate the response signal including a high frequency response component at the high frequency and at higher harmonics of the high frequency and a low frequency response component at the low frequency.

6. The system of claim 5, wherein the sensing device is configured to determine the inflation condition of the tire based on a maximum amplitude of the higher harmonics in the response signal during a period of the low frequency interrogating signal.

7. The system of claim 1, wherein the radiating device includes an amorphous metal.

8. The system of claim 1, wherein
the interrogating device is configured to transmit the interrogating signal including an interrogating alternating magnetic field signal,
the radiating device is configured to radiate the response signal including a response alternating magnetic field signal in response to the interrogating alternating magnetic field signal, and
the sensing device is configured to determine the inflation condition of the tire based on a frequency content of the response alternating magnetic field signal.

9. The system of claim 1, wherein the radiating device includes a glass-coated amorphous Cobalt-based metal alloy, said glass coating having a thickness of 2 to 10 microns and said amorphous Cobalt-based metal alloy having a diameter of 30 to 50 microns, and said Cobalt-based metal alloy containing 10% boron and 15% silicon by atomic percentage.

10. The system of claim 1, further comprising:
a vehicle configured to move across the ground and attached to the interrogating device, the sensing device and the tire,
wherein the tire is configured to rotate as the vehicle moves across the ground, and the interrogating device and the sensing device are attached to a portion of the vehicle that does not rotate as the vehicle moves across the ground.

11. The system of claim 10, wherein the vehicle further comprises a tire status indicator connected to the sensing device and configured to indicate the tire inflation status to an operator of the vehicle.

12. The system of claim 1, wherein the radiating device is not electrically connected to the interrogating device and the sensing device.

13. A tire configured to be monitored by a monitoring device configured to determine a tire inflation condition based on a frequency content of a signal received from the tire, said tire comprising:
an attached radiating device configured to radiate a response signal in response to an interrogating signal received from the monitoring device.

14. The tire of claim 13, wherein the radiating device is configured to vary a frequency content of the response signal based on an amount of deformation of the tire.

15. The tire of claim 13, wherein the radiating device is configured to passively radiate the response signal in response to the interrogation signal.

16. The tire of claim 13, wherein the radiating device is configured to decrease a higher harmonic component of the response signal when an amount of deformation of the tire increases.

17. The tire of claim 13, wherein
the radiating device is configured to receive the interrogating signal including a high frequency interrogating component at a high frequency and a low frequency interrogating component at a low frequency, and radiate the response signal including a high frequency response component at the high frequency and at higher harmonics of the high frequency and a low frequency response component at the low frequency.

18. The tire of claim 13, wherein the radiating device includes an amorphous metal.

19. The tire of claim 13, wherein
the radiating device is configured to receive the interrogating signal including an interrogating alternating magnetic field signal, and radiate the response signal including a response alternating magnetic field signal in response to the interrogating alternating magnetic field signal.

20. The tire of claim 13, wherein the radiating device includes a glass-coated amorphous Cobalt-based metal alloy, said glass coating having a thickness of 2 to 10 microns and said amorphous Cobalt-based metal alloy having a diameter of 30 to 50 microns, and said Cobalt-based metal alloy containing 10% boron and 15% silicon by atomic percentage.

21. The tire of claim 13, further comprising:
an attachment configured to be attached to a vehicle such that the tire is configured to rotate when the vehicle moves across the ground, said vehicle including the monitoring device,
wherein the monitoring device is attached to a portion of the vehicle that does not rotate as the vehicle moves across the ground.

22. The tire of claim 13, wherein the radiating device is not electrically connected to the monitoring device.

23. A sensor configured to sense an inflation condition of a tire that radiates a response signal in response to an interrogating signal, said sensor comprising:
an interrogating device configured to transmit an interrogating signal; and
a sensing device configured to receive the response signal from the tire and determine an inflation condition of the tire based on a frequency content of the received response signal.

24. The sensor of claim 23, wherein a frequency content of the response signal varies over time based on an amount of deformation of the tire.

25. The sensor of claim 23, wherein a higher harmonic component of the response signal is decreased when an amount of deformation of the tire increases.

26. The sensor of claim 23, wherein
the interrogating device is configured to transmit the interrogating signal including a high frequency interrogating component at a high frequency and a low frequency interrogating component at a low frequency, and
the sensing device is configured to receive the response signal including a high frequency response component at the high frequency and at higher harmonics of the high frequency and a low frequency response component at the low frequency.

27. The sensor of claim 23, wherein the sensing device is configured to determine the inflation condition of the tire based on a maximum amplitude of the higher harmonics in the response signal during a period of the low frequency interrogating signal.

28. The sensor of claim 23, wherein
the interrogating device is configured to transmit the interrogating signal including an interrogating alternating magnetic field signal, and
the sensing device is configured to receive the response signal including a response alternating magnetic field signal in response to the interrogating alternating magnetic field signal, and determine the inflation condition of the tire based on a frequency content of the response alternating magnetic field signal.

29. The sensor of claim 23, further comprising:
a vehicle configured to move across the ground and attached to the interrogating device, the sensing device and the tire,
wherein the tire is configured to rotate as the vehicle moves across the ground, and the interrogating device and the sensing device are attached to a portion of the vehicle that does not rotate as the vehicle moves across the ground.

30. The sensor of claim 29, wherein the vehicle further comprises a tire status indicator connected to the sensing device and configured to indicate the tire inflation status to an operator of the vehicle.

31. The sensor of claim 1, wherein the interrogating device and the sensing device are not electrically connected to the tire.

32. A method for monitoring an inflation condition of a tire, said method comprising steps of:
transmitting an interrogating signal from an interrogating device;
radiating a response signal, from a radiating device attached to the tire, in response to the interrogating signal;
receiving the response signal at a sensing device; and
determining an inflation condition of the tire based on a frequency content of the received response signal.

33. The method of claim 32, wherein the radiating further comprises varying a frequency content of the response signal based on an amount of deformation of the tire.

34. The method of claim 32, wherein the radiating further comprises passively radiating the response signal in response to the interrogation signal.

35. The method of claim 32, wherein the radiating further comprises decreasing a higher harmonic component of the response signal when an amount of deformation of the tire increases.

36. The method of claim 32, wherein
the transmitting further comprises transmitting the interrogating signal including a high frequency interrogating component at a high frequency and a low frequency interrogating component at a low frequency, and
the radiating further comprises radiating the response signal including a high frequency response component at the high frequency and at higher harmonics of the high frequency and a low frequency response component at the low frequency.

37. The method of claim 36, wherein the determining further comprises determining the inflation condition of the tire based on a maximum amplitude of the higher harmonics in the response signal during a period of the low frequency interrogating signal.

38. The method of claim 32, wherein the radiating further comprises radiating the response signal from a device including an amorphous metal.

39. The method of claim 32, wherein
the transmitting further comprises device transmitting the interrogating signal including an interrogating alternating magnetic field signal,
the radiating further comprises radiating the response signal including a response alternating magnetic field signal in response to the interrogating alternating magnetic field signal, and
the determining further comprises determining the inflation condition of the tire based on a frequency content of the response alternating magnetic field signal.

40. The method of claim 32, wherein the radiating further comprises radiating the response signal from a device that includes a glass-coated amorphous Cobalt-based metal alloy, said glass coating having a thickness of 2 to 10 microns and said amorphous Cobalt-based metal alloy having a diameter of 30 to 50 microns, and said Cobalt-based metal alloy containing 10% boron and 15% silicon by atomic percentage.

41. The method of claim 32, further comprising:
attaching a vehicle configured to move across the ground to the interrogating device, the sensing device and the tire;
rotating the tire as the vehicle moves across the ground; and
holding stationary the interrogating device and the sensing device as the vehicle moves across the ground.

42. The method of claim 41, further comprising:
indicating the tire inflation status to an operator of the vehicle.

43. The method of claim 32, further comprising:
electrically isolating the radiating device from the interrogating device and the sensing device.

44. A computer program product storing program instructions which, when executed by a processor for monitoring a tire, result in execution of steps comprising:
transmitting an interrogating signal from an interrogating device;
radiating a response signal, from a radiating device attached to the tire, in response to the interrogating signal;
receiving the response signal at a sensing device; and
determining an inflation condition of the tire based on a frequency content of the received response signal.

45. The computer program product of claim 44, wherein the radiating further comprises varying a frequency content of the response signal based on an amount of deformation of the tire.

46. The computer program product of claim 44, wherein the radiating further comprises passively radiating the response signal in response to the interrogation signal.

47. The computer program product of claim 44, wherein the radiating further comprises decreasing a higher harmonic component of the response signal when an amount of deformation of the tire increases.

48. The computer program product of claim 44, wherein
the transmitting further comprises transmitting the interrogating signal including a high frequency interrogating component at a high frequency and a low frequency interrogating component at a low frequency, and
the radiating further comprises radiating the response signal including a high frequency response component at the high frequency and at higher harmonics of the high frequency and a low frequency response component at the low frequency.

49. The computer program product of claim 44, wherein the determining further comprises determining the inflation condition of the tire based on a maximum amplitude of the higher harmonics in the response signal during a period of the low frequency interrogating signal.

50. The computer program product of claim 44, wherein the radiating further comprises radiating the response signal from a device including an amorphous metal.

51. The computer program product of claim 44, wherein
the transmitting further comprises device transmitting the interrogating signal including an interrogating alternating magnetic field signal,
the radiating further comprises radiating the response signal including a response alternating magnetic field signal in response to the interrogating alternating magnetic field signal, and
the determining further comprises determining the inflation condition of the tire based on a frequency content of the response alternating magnetic field signal.

52. The computer program product of claim 44, wherein the radiating further comprises radiating the response signal from a device that includes a glass-coated amorphous Cobalt-based metal alloy, said glass coating having a thickness of 2 to 10 microns and said amorphous Cobalt-based metal alloy having a diameter of 30 to 50 microns, and said Cobalt-based metal alloy containing 10% boron and 15% silicon by atomic percentage.

53. The computer program product of claim 44, further comprising:
indicating the tire inflation status to an operator of a vehicle.

54. The computer program product of claim 44, further comprising:
electrically isolating the radiating device from the interrogating device and the sensing device.
